(19) United States
(12) Patent Application Publication
(10) Pub. No.: US 2017/0258010 A1
(43) Pub. Date: Sep. 14, 2017

(54) PLANT CULTIVATION METHOD AND FACILITY

(71) Applicant: MITSUBISHI PLASTICS AGRI DREAM CO., LTD., Chuo-ku (JP)

(72) Inventors: Akio NAKAMINAMI, Tsukubamirai-shi (JP); Junya FUSE, Tsukubamirai-shi (JP)

(73) Assignee: MITSUBISHI PLASTICS AGRI DREAM CO., LTD., Chuo-ku (JP)

(21) Appl. No.: 15/310,135

(22) PCT Filed: Jan. 30, 2015
(86) PCT No.: PCT/JP2015/052694

§ 371 Date: Nov. 10, 2016

(30) Foreign Application Priority Data
May 21, 2014 (JP) 2014-105370

(51) Int. Cl. A01G 1/00; A01G 9/20; A01G 31/02; A01G 7/00; A01G 9/24; A01G 7/04

(52) U.S. Cl. CPC A01G 1/001; A01G 9/246; A01G 7/045; A01G 31/02; A01G 7/00; A01G 9/20

(57) ABSTRACT

Provided is a method and a facility of plant cultivation in which leaf vegetables, fruit vegetables, and the like that are of stable quality can be cultivated at a relatively low cost and in which the period of cultivation can be stabilized. A plant cultivation method and a facility comprising a first step of raising seedlings, and a second step of planting the seedlings into a cultivation field and cultivating the seedlings, wherein, in the first step, the seedlings are cultivated with only artificial light; in the second step, the seedlings are cultivated with only sunlight; and the seedlings raised in the first step are sequentially transplanted to the cultivation field for the second step and are cultivated.

### TECHNICAL FIELD

The present invention relates to a method and facility of plant by nutriculture, in particular, to a plant nutricultivating method including a first step of raising seedlings with artificial light, and a second step of planting the seedlings raised in the first step into a cultivation field and cultivating the seedlings with sunlight, and to a facility therefor.

### BACKGROUND ART

Known cases of cultivation of leaf vegetables and fruit vegetables are mostly open-field cultivation or greenhouse cultivation. However, such cultivation methods have problems in that vegetables can not be supplied stably because of factors such as unseasonable weather, weather or agricultural-water conditions limit available cultivation sites, discharged fertilizer puts a load on the natural environment, the use of agricultural chemicals is inevitable for preventing weeding or damage by disease or insect pests, and so forth.

Hence, in recent years, some attempts of cultivating leaf vegetables and fruit vegetables hydroponically have been conducted (see PTL 3 and 4). Hydroponic cultivation is beneficial in that vegetables can be supplied stably regardless of weather, there is no limitation on the cultivation site, the amount of fertilizer that is discharged is small, cultivation with no use of agricultural chemicals is possible, and so forth. Furthermore, the quality of vegetables can be more stabilized, and the period of cultivation can be reduced. In such hydroponic cultivation, even a worker who is not engaged in agriculture can cultivate vegetables of an acceptable level of quality relatively easily.

Such hydroponic cultivation methods include a cultivation method in which artificial light is basically used, and a hybrid cultivation method in which artificial light and sunlight are used. In PTL 1 (JP 2006-262750 A), a cultivation apparatus is disclosed that includes a water tank from which a nutrient solution is supplied and that is provided in a plant-cultivation room equipped with air-conditioning means that conditions temperature, humidity, and carbon-dioxide concentration, the cultivation apparatus emitting artificial light for photosynthesis. In PTL 2 (JP 2011-177107 A), a cultivation method for growing plants is disclosed in which both light from an illumination device and sunlight from the sun are used as light necessary for growing plants. Such a cultivation method using artificial light can stabilize the period of cultivation and growing conditions of vegetables and the like more than in known cultivation methods in which only sunlight is used.

PTL 1: JP 2006-262750 A

PTL 2: JP 2011-177107 A

PTL 3: JP H8-205700 A

PTL 4: JP 2002-291349 A

To cultivate vegetables from a state of seedlings and to harvest them, a cultivation field having a specific size is necessary. If vegetables are cultivated in a large cultivation field with artificial light, illumination equipment and electricity cost a fortune.

Equipment and electricity costs in cultivation with only sunlight (open-field cultivation, greenhouse cultivation, or the like) are lower than in cultivation with artificial light. In known open-field cultivation or greenhouse cultivation, however, it is difficult to control the growth of vegetables and the like that are to be cultivated to be uniform. Hence, the timing of harvesting of such vegetables becomes unstable.

### SUMMARY OF INVENTION

It is an object of the present invention to provide a method and facility of plant cultivation in which leaf vegetables, fruit vegetables, and the like that are of stable quality can be cultivated at a relatively low cost and in which the period of cultivation can be stabilized.

According to the present invention, only artificial light is used in a first step of producing seedlings, only sunlight is used in a second step of planting the seedlings into a cultivation field and cultivating the seedlings, and the seedlings grown in the seedling-raising step are sequentially transplanted, in units of seedlings at the same stage, to the cultivation field in which only sunlight is used and are cultivated therein, whereby stable cultivation of vegetables or the like is realized.

That is, the present invention is summarized as follows.

[1] A plant cultivation method comprising a first step of raising seedlings, and a second step of planting the seedlings into a cultivation field and cultivating the seedlings,

wherein, in the first step, the seedlings are cultivated with only artificial light;

in the second step, the seedlings are cultivated with only sunlight; and

the seedlings raised in the first step are sequentially transplanted to the cultivation field for the second step and are cultivated.

[2] The plant cultivation method according to [1], wherein the cultivation field is provided with at least one cultivation-bed, a master tank in which a nutrient solution is stored, and at least one sub tank to which the nutrient solution is supplied from the master tank; and

the nutrient solution is supplied from the sub tank to the cultivation-bed.

[3] The plant cultivation method according to [2], wherein the nutrient solution used in the cultivation-bed is returned to the sub tank from which the nutrient solution has been supplied to said cultivation-bed.

[4] The plant cultivation method according to [2] or [3],

wherein the cultivation-bed is arranged with a gradient; the cultivation-bed carries a planting panel having a number of planting holes for planting seedlings; seedlings are put into the planting holes; and the seedlings are cultivated by causing the nutrient solution to flow along a bottom surface of the cultivation-bed.

[5] The plant cultivation method according to any one of [2] to [4], wherein, in a late stage of cultivation of plants in the cultivation-bed, the supply of the nutrient solution to the cultivation-bed is stopped, and water is supplied to the cultivation-bed.

[6] The plant cultivation method according to any one of [1] to [5], wherein the first step is performed in a seedling-raising apparatus; the seedling-raising apparatus includes a completely light-shielded closed structure; a plurality of raising modules each including a plurality of seedling-raising shelves are provided in an internal space of the closed structure; an air-conditioning device is provided in the internal space of the closed structure; cell trays in each of which a culture medium is provided are placed on the respective seedling-raising shelves of the raising modules; light is applied to each of the cell trays from above by an artificial illumination device; and seedlings are raised while each of the cell trays is irrigated from a bottom face of the cell tray by an automatic irrigation device.

[7] A plant cultivation facility for cultivating plants, the facility comprising: a young-seedling-raising area in which young seedlings of the plants are cultivated with only artificial light; and a transplanted seedlings cultivation area in which the seedlings grown in the young-seedlings-raising area are cultivated with only sunlight.

[8] The plant cultivation facility according to [7], wherein the transplanted seedlings cultivation area is provided with a master tank in which a nutrient solution is stored, at least one sub tank to which the nutrient solution is supplied from the master tank, and at least one cultivation-bed to which the nutrient solution is supplied from the sub tank.

[9] The plant cultivation facility according to [8], wherein the transplanted seedlings cultivation area is further provided with a return circuit in which the nutrient solution used in the cultivation-bed is returned to the sub tank.

[10] The plant cultivation facility according to [8] or [9], wherein the cultivation-bed is arranged with a gradient; the cultivation-bed carries a planting panel having a number of planting holes for planting seedlings; seedlings are put into the planting holes; and the seedlings are cultivated by causing the nutrient solution to flow along a bottom surface of the cultivation-bed.

[11] The plant cultivation facility according to any one of [8] to [10], wherein, in a late stage of cultivation of plants in the cultivation-bed, the supply of the nutrient solution to the cultivation-bed is stopped, and water is supplied to the cultivation-bed.

[12] The plant cultivation facility according to any one of [7] to [11], wherein the seedlings are raised in the young-seedling-raising area with only artificial light; the young-seedling-raising area is provided with a completely light-shielded closed structure; a plurality of raising modules each including a plurality of seedling-raising shelves are provided in an internal space of the closed structure; an air-conditioning device is provided in the internal space of the closed structure; cell trays in each of which a culture medium is provided are placed on the respective seedling-raising shelves of the raising modules;

light is applied to each of the cell trays from above by an artificial illumination device; and seedlings are raised while each of the cell trays is irrigated from a bottom face of the cell tray by an automatic irrigation device.

In the present invention, it is preferable that the number of days to be spent for raising the seedlings in the first step is about 20 to 60%, particularly about 30 to 50%, of the total number of days to be spent for the cultivation in the first and second steps. In the case of spinach, the first step takes about 12 days, and the second step takes about 14 days (a total of about 26 days). In the case of lettuce, the first step takes about 20 days, and the second step takes about 40 days (a total of about 60 days).

### Advantageous Effects of Invention

According to the present invention, seedlings are produced with only artificial light in the first step, and the seedlings are planted into the cultivation field and are cultivated with only sunlight in the second step. The seedlings grown in the first step are sequentially transplanted in units of seedlings at the same stage and are cultivated in the second step. Hence, the period of raising seeds into seedlings can be stabilized in units of cultivation of one block. Thus, the period of cultivation in the process before the seedlings are transplanted to the cultivation field can be made constant. Since the seedlings are cultivated with only sunlight in the cultivation field, low-cost cultivation is realized. All of the vegetables in one specific block can be shipped in the same state of growth and at a time.

According to the present invention, various leaf vegetables such as spinach, lettuce, mustard spinach, bok choy, ruccola, Welsh onion, and herbs can be mainly cultivated.

### BRIEF DESCRIPTION OF DRAWINGS

FIG. 1 is a plan view of a plant-raising system including multi-shelf plant-raising devices according to an embodiment.

FIG. 2 is a sectional view taken along line II-II illustrated in FIG. 1.

FIG. 3 is a front view of any of the multi-shelf plant-raising devices according to the embodiment.

FIG. 4 is a sectional view taken along line IV-IV illustrated in FIG. 3.

FIG. 5 is a plan view of a tray included in the multi-shelf plant-raising device according to the embodiment.

FIG. 6 is a perspective view of the tray illustrated in FIG. 5.

FIG. 7 is a sectional view taken along line VII-VII illustrated in FIG. 5.

FIG. 8 is a perspective view of a cultivation-bed.

FIG. 9 is a sectional view of a ridge in FIG. 8.

FIG. 10 is a sectional view of the cultivation-bed in which plants are being raised.

FIG. 11 is a plan view illustrating a second step.

### DESCRIPTION OF EMBODIMENTS

The present invention will now be described in further detail but is not limited to the following embodiment, as long as the advantageous effects of the present invention are produced.

[First Step]

In a first step, seedlings are produced with only artificial light. In the first step, it is important to produce seedlings that are at the same stage. Here, the same stage means that seedlings have grown to substantially the same extent. For example, in the case of spinach, the seedlings at the same stage each have two to three leaves. In terms of the state of growth of the roots in seedling-root pots, the seedlings at the same stage each have roots spreading to such an extent that the seedling can be easily taken out of a seedling-raising hole in which the seedling is raised, and a culture medium forming the seedling-root pot retains its shape, without crumbling, when the seedling is taken out.

Seedlings that are produced in the first step are occasionally referred to as “young seedlings,” and a facility in which seedlings are raised in the first step is referred to as “young-seedling-raising area.”

To produce seedlings at the same stage, it is preferable, but is not especially limited, to raise seedlings in a seedling-raising apparatus that includes multiple seedling-raising shelves and is provided in a closed structure that is completely light-shielded.

It is preferable that a plurality of box-shaped raising modules each including a plurality of seedling-raising shelves are provided in the closed structure; and an air-conditioning device is provided in the internal space of the closed structure. It is preferable that the raising modules each include a plurality of cell trays in each of which a culture medium for raising the seedlings is provided; and the cell trays are placed on each shelf of the multi-stage type seedling-raising shelves. It is preferable that an artificial illumination device that applies light to the plants is provided above the cell trays placed on the seedling-raising shelves, and an automatic irrigation device that irrigates the cell trays from the bottom faces of the cell trays is provided.

The use of such a seedling-raising apparatus allows the raising of seedlings to be controlled in units of one block and also allows the transplanting work in the second step to be performed in units of one block. Thus, the work efficiency is improved.

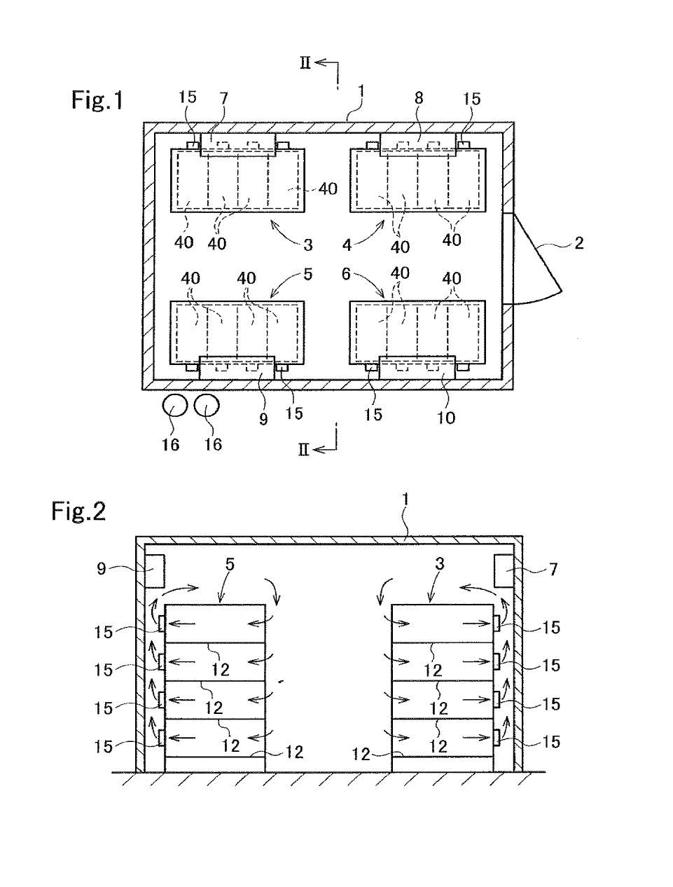

Referring to FIGS. 1 to 7, a preferable configuration of the seedling-raising apparatus used in the first step will now be described. As illustrated in FIGS. 1 and 2, a plurality (four in the case illustrated in the drawings) of box-shaped multi-shelf raising modules 3, 4, 5, and 6 are provided in a room of a closed building structure 1 that is formed of heat-insulating walls and is completely light-shielded.

In FIG. 1, two multi-shelf raising modules 3 and 4 are arranged in one row with the open front faces thereof facing toward the same side, and two multi-shelf raising modules 5 and 6 are also arranged in one row with the open front faces thereof facing toward the same side. The two rows are arranged in the room such that the open front faces thereof face each other. A working space that is enough for one or a plurality of workers to work is provided between the two rows. A space having a width of about 50 to 500 mm is provided between the wall of the room and the rear face of each of the multi-shelf raising modules 3 to 6, whereby a passageway allowing air that has flowed through the multi-shelf raising modules 3 to 6 to flow is provided.

It is preferable to provide an air curtain on the inner side of a door 2 for entering or exiting from the room, because the entry of the outside air at the entry or exit of workers can be prevented.

The room is equipped with air-conditioning devices 7 to 10 provided on upper parts of the walls thereof. The air-conditioning devices 7 to 10 has a function of adjusting the temperature and humidity of the air in the room and circulating the air having temperature and humidity adjusted to preset conditions.

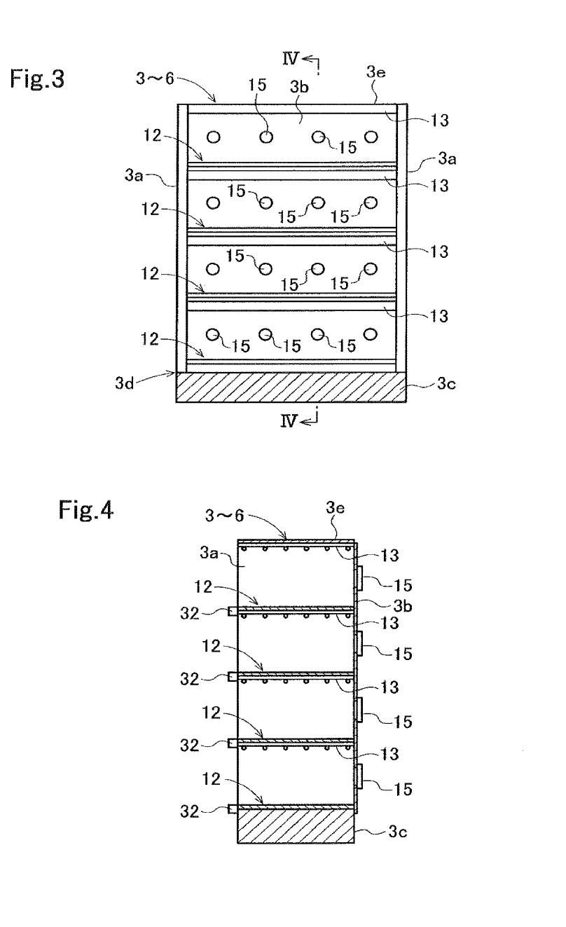

As illustrated in FIGS. 3 and 4, the multi-shelf raising modules 3 to 6 each have a box-like structure with the front face thereof being open and include a base 3c, left and right side panels 3a, a rear panel 3b provided at the rear, and a top panel 3e provided at the top. The box-like structure is provided thereinside with a plurality of seedling-raising shelves 12 arranged at regular intervals in the vertical direction.

It is preferable that the height of each of the multi-shelf raising modules 3 to 6 is set to about 2000 mm, which is suitable for the worker to work; the width of each of the seedling-raising shelves 12 is set to such a value that a plurality of resin cell trays each including tens to hundreds of cells (small pots) arranged in a matrix pattern can be placed thereon side by side and the temperature and the humidity in the space above each of the shelves 12 can be adjusted to be constant, that is, the width be about 1000 mm to 2000 mm, for example; and the depth of each of the seedling-raising shelves 12 is set to 500 mm to 1000 mm. The seedling-raising shelves 12 each carry a plurality of cell trays 40 (see FIGS. 1 and 7) placed thereon substantially horizontally. Typically, each of the cell trays 40 has a size defined by a width of about 300 mm and a length of about 600 mm.

The lowest one of the seedling-raising shelves 12 is placed on the base 3c. The levelness of the seedling-raising shelf 12 is adjustable by an adjuster (not illustrated) provided to the base 3c.

The seedling-raising shelves 12 are each provided with an irrigation device 30 to be described below.

The second and subsequent seedling-raising shelves 12 counting from the bottom and the top panel 3e are each provided on the underside thereof with light-emitting members 13b configured to apply light to plants raised in the cell trays 40 on a corresponding one of the seedling-raising shelves 12 that is positioned directly therebelow. In the present embodiment, artificial illuminators 13 excluding the topmost one are each attached to the underside of an irrigation tray 31 to be described below.

The artificial illuminators 13 each include a box 13a, the light-emitting members 13b provided on the underside of the box 13a, a power supply unit (not illustrated) provided in the box 13a, and so forth. The light-emitting members of the artificial illuminators 13 are preferably fluorescent lamps, LED's, or the like.

As illustrated in FIG. 4, the rear panel 3b has vent holes in portions thereof that are on the rear side of respective spaces (seedling-raising spaces) between adjacent ones of the seedling-raising shelves 12 and between the topmost seedling-raising shelf 12 and the top panel 3e, and air fans 15 are provided at the respective vent holes. When the air fans 15 are activated, a circulating flow of air represented by arrows in FIG. 2 is generated in the room. That is, air whose temperature and humidity have been adjusted by each of the air-conditioning devices 7 to 10 is taken into the seedling-raising spaces between the seedling-raising shelves 12 from the open front face a corresponding one of the multi-shelf raising modules 3 to 6, is exhausted from the vent holes toward the back of the rear panel 3b, goes upward between the back of the rear panel 3b and the building wall, is taken into the corresponding one of the air-conditioning devices 7 to 10, is conditioned to have appropriate temperature and humidity, and is blown toward the side of the open front face of the corresponding one of the multi-shelf raising modules 3 to 6 again.

As illustrated in FIGS. 1 and 2, if two rows formed of the multi-shelf raising modules 3 and 4 and the multi-shelf raising modules 5 and 6 are arranged such that a working space is provided therebetween, the working space also functions as a passageway for the air circulation, producing an effective circulating airflow.

When the circulating airflow passes through the seedling-raising spaces provided in the multi-shelf raising modules 3 to 6, water vapor generated from the irrigation devices, the culture medium, the plants, and so forth and the heat radiated from the artificial illuminators 13 accompany the circulating airflow. Such air is made to circulate constantly while being conditioned to have appropriate temperature and humidity by the air-conditioning devices 7 to 10, whereby the environment in the room can be maintained at the temperature and the humidity that are most suitable for the growth of plants. A velocity of the airflow passing through the seedling-raising spaces is preferably 0.1 m/sec or higher, more preferably 0.2 m/sec or higher, or much more preferably 0.3 m/sec or higher. A velocity of the airflow that is too high may cause a problem in the growth of the plants. Therefore, in general, the velocity of the airflow is preferably 2.0 m/sec or lower.

In the present embodiment, air under negative pressure is taken from the front side of each of the seedling-raising spaces and passes through the fans 15 toward the rear side of the shelves. Alternatively, air under positive pressure may be fed in the reverse direction from the rear side of the shelves toward the front side. However, if air under negative pressure is made to flow from the front side toward the rear side of the shelves, the airflow in the seedling-raising spaces becomes more uniform.

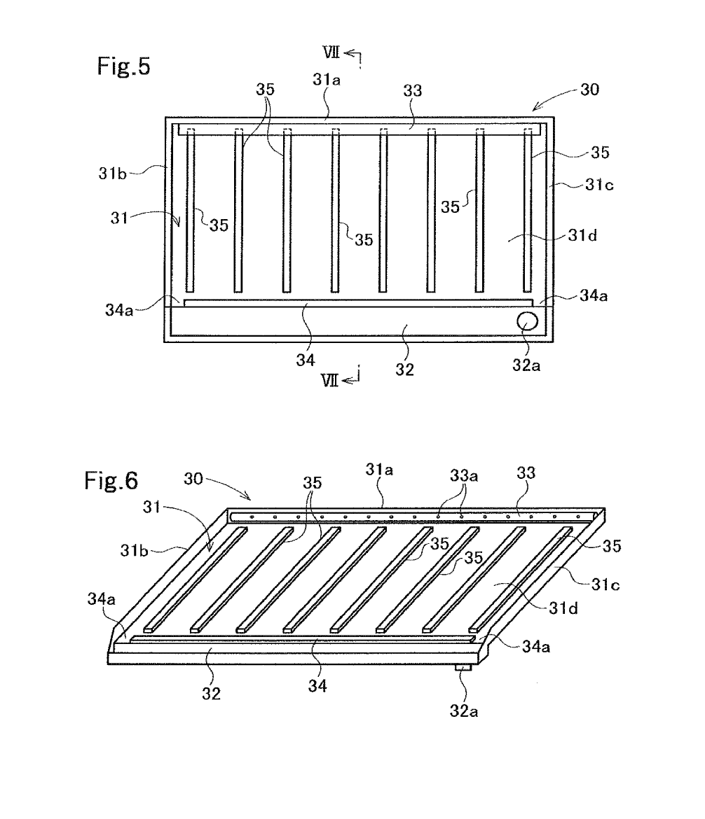

According to the present embodiment, the box 13a of the artificial illuminator 13 forms a shelf as the seedling-raising shelf 12, and the irrigation tray 31 is placed on the artificial illuminator 13, whereby the cell trays 40 placed on the irrigation tray 31 are irrigated from the bottom faces thereof. An exemplary configuration of the irrigation device 30 will now be described with reference to FIGS. 5 to 7. FIG. 5 is a plan view, FIG. 6 is a perspective view, and FIG. 7 is a sectional view, taken along line VII-VII illustrated in FIG. 5, of the irrigation device.

The irrigation device 30 includes the irrigation tray 31, which has a rectangular shape and includes a bottom board 31d from which sidewalls 31a, 31b, and 31c extend upright along the rear, left, and right sides, respectively, thereof. The front side of the irrigation tray 31 along which no sidewall extends has a drainage ditch 32 adjoining the bottom board 31d. The drainage ditch 32 has a drainage outlet 32a at one end thereof. The drainage ditch 32 and the bottom board 31d are partitioned by a dam 34. Notches 34a provided at two respective ends of the dam 34 allow a nutrient solution to flow into the drainage ditch 32. Furthermore, a water supply pipe 33 from which the nutrient solution is supplied into the irrigation tray 31 extends along the sidewall 31a on the rear side of the irrigation tray 31. The nutrient solution is supplied onto the tray 31 from a plurality of small holes 33a provided in the water supply pipe 33.

The bottom board 31d of the irrigation tray has, on an upper surface thereof, a plurality of ribs 35 each having a height of about 7 mm. The ribs 35 extend toward the drainage ditch 32 and parallel to one another. The cell trays 40 are placed over the ribs 35.

As illustrated in FIG. 4, the irrigation trays 31 of the irrigation devices 30 have such a size that, when placed on the respective seedling-raising shelves 12 of the multi-shelf raising modules 3 to 6, the drainage ditches 32 project from the open front faces of the raising devices 3 to 6. Since the drainage ditches 32 project from the open front faces of the raising devices, it is easy to collect the nutrient solution drained from the drainage outlets 32a of the drainage ditches 32 of the irrigation trays 31 placed on the respective seedling-raising shelves 12 and to drain the collected nutrient solution to the outside of the building structure 1.

When the nutrient solution is continuously supplied from the small holes 33a provided in the water supply pipe 33 of each of the irrigation devices 30, the nutrient solution is dammed by the dam 34 and is collected up to a predetermined level, forming a pool. While the nutrient solution is being supplied from the water supply pipe 33, the nutrient solution flows through the notches 34a into the drainage ditch 32 little by little. It is preferable that the level of the pool in the irrigation tray 31 is maintained at, for example, about 10 to 12 mm by adjusting the amount of supply of the nutrient solution and the amount of discharge of the nutrient solution from the notches 34a. Water is taken up by capillary action through cell holes 42, provided at the bottoms of the respective cells 41 of each of the cell trays 40 placed over the ribs 35, into the culture medium provided in the respective cells. Thus, the culture medium in all of the cells 41 are saturated with water in a short time.

The artificial illuminator 13 is attached to the underside of the bottom board 31d of each of the irrigation trays 31.

In each of the irrigation devices 30, as illustrated in FIG. 7, the upper surface of the bottom board 31d of the irrigation tray 31 slopes toward the drainage ditch 32. Hence, when irrigation is stopped, the nutrient solution can be drained into the drainage ditch 32 in a short time. Furthermore, if the upper surface of the bottom board 31d has a slope and if the height of the ribs 35 is varied such that tops 35a of the ribs extend horizontally, the cell trays 40 placed over the ribs 35 can be retained to extend horizontally.

The cell trays 40 placed in the irrigation tray 31 are each an array of tens to hundreds of cells 41 arranged in a matrix pattern in such a manner as to form a tray shape.

To artificially supply carbon dioxide that is consumed by seedlings undergoing photosynthesis, liquefied-carbon-dioxide cylinders 16 are provided on the outside of the building structure 1 as illustrated in FIG. 1. Carbon dioxide is supplied from the liquefied-carbon-dioxide cylinders 16 such that the concentration thereof in the room that is measured by a carbon-dioxide-concentration-measuring device is maintained at a constant level.

If seedlings are raised in the above seedling-raising apparatus, environmental conditions such as light quantity, temperature, humidity, carbon dioxide, and water content that are suitable for raising the seedlings can be adjusted automatically. Since all of the seedlings on each of the seedling-raising shelves can be raised in the same environment, the uniformity in the quality of the resulting seedlings can be increased.

[Second Step]

In the second step, the seedlings raised in the first step are preferably planted in a cultivation-bed and are cultivated with only sunlight (that is, without using any artificial illumination for plant cultivation). In the second step, although no artificial illumination for cultivation is used, it is obvious that an illumination for indoor work in the cultivation field may be used.

The facility for cultivating the seedlings in the second step is referred to as “transplanted seedlings cultivation area.”

In the second step, it is preferable, but is not especially limited, to arrange the cultivation-bed with a slope; to provide, on the upper surface of the cultivation-bed, a planting panel having a number of planting holes provided for planting seedlings; and to cause the nutrient solution to flow down naturally along the bottom surface of the cultivation-bed so that the roots of the seedlings on the cultivation-bed can absorb the nutrient solution.

It is preferable that the cultivation-bed have, on the upper surface thereof, ridges each extending below some of the planting holes of the planting panel. The width of the ridges is determined by the diameter of the seedling-root pots to be used. If the width of the ridges is smaller than the diameter of the seedling-root pots, the seedling-root pots may slip off the rib-like ridge and be tilted. Preferably, the width of the ridges is larger than the diameter of the seedling-root pots to be used and smaller than a value obtained by adding 4 mm to the diameter of the seedling-root pots.

The nutrient solution on the upper surface of the cultivation bed flows along furrows running between adjacent ones of the ridges of the cultivation-bed. Each of the seedling-root pots inserted into the planting holes is placed on the upper surface of the ridge. Since the seedling-root pots are not washed by the flow of the nutrient solution, the culture medium in the seedling-root pot is less likely to crumble or to be washed away.

With such a cultivation-bed, two kinds of roots that are in different forms and have different functions can be produced: water roots growing in the water and moisture roots including a number of root hairs retained in the moist air. Water roots mainly absorb the fertilizer and water in the nutrient solution. Moisture roots mainly absorb oxygen directly from the moist air.

In such a cultivation method, plants can be cultivated without depending only on dissolved oxygen in the nutrient solution. Hence, even in the cultivation during a high-temperature season in which there tends to be a lack of dissolved oxygen, the roots of the plants do not become short of oxygen.

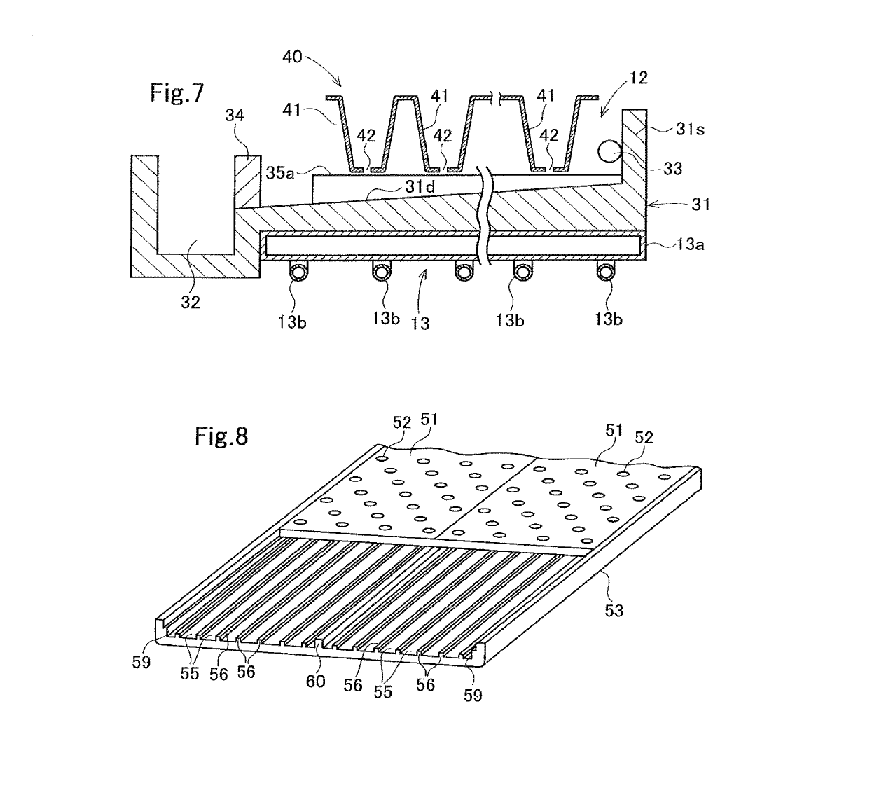

A preferable configuration of the cultivation-bed will now be described with reference to FIGS. 8 to 10.

A planting panel 51 made of light-weight foamed polystyrene has a number of planting holes 52 penetrating therethrough. The size of the planting panel 51 is defined by, for example, a width of 600 mm, a depth of 1000 mm, and a thickness of 35 mm. The planting holes 52 may each have an inverted conical shape. Preferably, however, the planting hole 52 has a cylindrical shape whose top and bottom diameters are the same. The size of the planting holes 52 is larger than the diameter of seedling-root pots 54 to be used. The interval between adjacent ones of the planting holes 52 is set to a value that is appropriate for the cultivation of crops. For example, in the case of spinach, supposing that the planting panel 51 has the above size, a total of 45 cylindrical planting holes 52 each having a diameter of 27 mm are arranged at intervals of 118 mm and in a diamond pattern.

A cultivation-bed 53 that carries the planting panels 51 and 51 on the upper surface thereof is made of light-weight foamed polystyrene, as with the planting panels 51. In the case illustrated in the drawings, two planting panels 51 and 51 are supported by step portions 59 and 59 provided on two respective sides of the cultivation-bed 53 and by a bearing portion 60 provided at the center of the upper surface of the cultivation-bed 53. The cultivation-bed 53 has a size defined by, for example, a width of 1260 mm, a depth of 1000 mm, and a sidewall height of 100 mm.

A plurality of ridges 56 each extend in the longitudinal direction continuously on the bottom surface in such a manner as to pass through corresponding ones of the positions exactly below the planting holes 52 provided in the planting panel 51. A nutrient solution L flows along furrows 55 each running between adjacent ridges 56 and 56. The height of the ridges 56 is determined in relation to the depth of the flow of the nutrient solution L. The width of the ridges 56 is determined in relation to the diameter of the seedling-root pots 54 to be used. If the ridges 56 are too low, the probability that the seedling-root pots 54 on the ridges 56 may be washed away by the nutrient solution L increases, which is not preferable. In contrast, if the ridges 56 are too high, the seedling-root pots 54 are positioned too far apart from the surface of the pool of nutrient solution L and the supply of water to the seedling-root pots 54 tends to become insufficient. Such a situation unpreferably slows the growth. If the width of the ridges 56 is smaller than the diameter of the seedling-root pots 54, the seedling-root pots 54 may slip off the rib-like ridges 56 and be tilted. Preferably, the ridges 56 are higher than the depth of the flow of the nutrient solution L by about 2 to 3 mm. Furthermore, the width of the ridges 56 is preferably larger than the diameter of the seedling-root pots 54 to be used and smaller than the value obtained by adding 4 mm to the diameter of the seedling-root pots. The interval between adjacent ones of the ridges 56 is equal to the interval between adjacent ones of the planting holes 52.

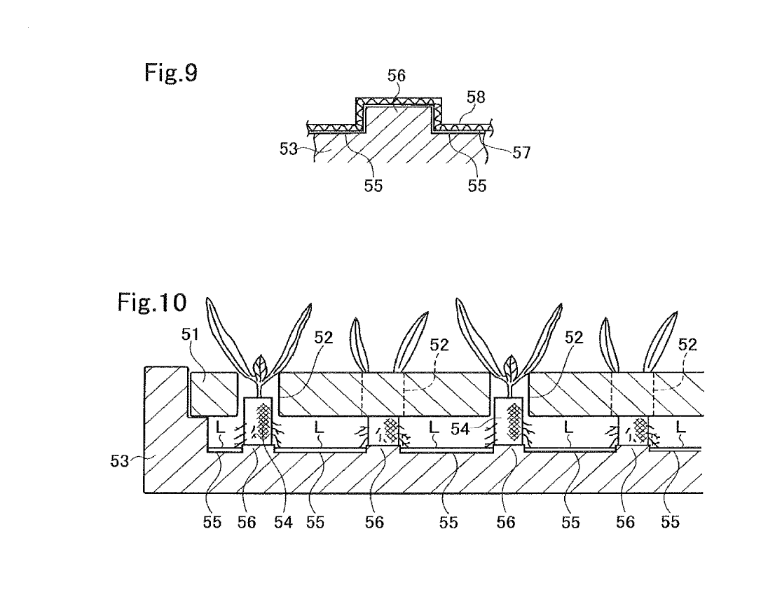

Preferably, a plurality of cultivation-beds 53 are connected in the longitudinal direction thereof and are arranged with a gradient of about 1/80. In such a case, as illustrated in FIG. 9, it is preferable that the entirety of the upper surfaces of the continuously connected cultivation-beds 53 is covered with a plastic sheet 57 so that water leakage from the connections is prevented. Furthermore, a hydrophilic material 58 such as fabric or paper is preferably provided over the plastic sheet 57. The hydrophilic material 58 is intended for taking up the solution by capillary action.

As illustrated in FIG. 10, the planting panel 51 is placed over the cultivation-bed 53, and the seedling-root pots 54 are dropped into the respective planting holes 52. The seedling-root pots 54 are each placed on a corresponding one of the ridges 56 of the cultivation-bed 53 that is positioned exactly below the planting hole 52 of interest. Subsequently, the nutrient solution L is supplied into the furrows 55 from the upstream side toward the downstream side of the cultivation-bed 53. The surface level of the pool in each furrow when the flow rate of the nutrient solution L per bed is 10 liters per minute is about 2 to 3 mm, which is about half the height of the ridges 56. This produces a humid space with a height of about 25 mm between the underside of the planting panel 51 and the surface of the pool of nutrient solution L in the furrow.

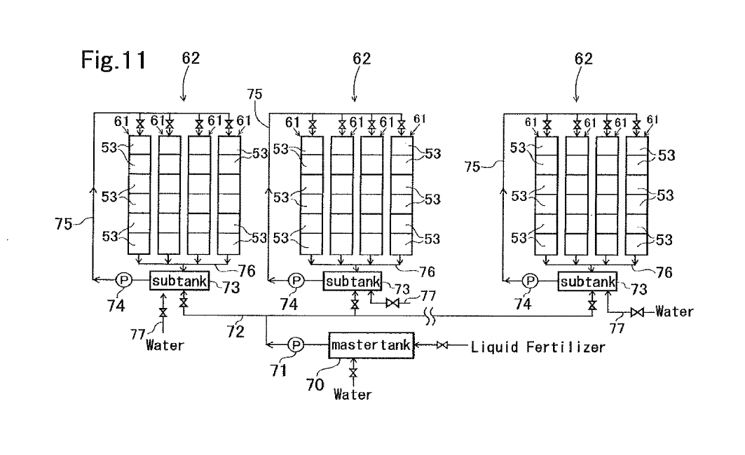

As illustrated in FIG. 11, it is preferable that the cultivation field used in the second step is provided with a master tank 70 for storing the nutrient solution, at least one sub tank 73 to which the nutrient solution is supplied from the master tank 70 is provided, and at least one cultivation-bed 53 to which the nutrient solution is supplied from a corresponding one of the sub tanks 73 is provided. The nutrient solution, which is prepared to have a predetermined concentration in the master tank 70, is distributed to the sub tanks 73 through a pump 71 and a piping 72 and is supplied to the cultivation-beds 53 through pumps 74 and pipes 75.

In FIG. 11, the cultivation field is provided with a plurality of cultivation-beds 53, in which leaf vegetables, fruit vegetables, and the like are cultivated. The plurality of cultivation-beds 53 are supplied, via the sub tanks 73, with a nutrient solution prepared in the master tank 70. Thus, a nutrient solution prepared to have a uniform concentration in the master tank 70 can be constantly supplied to each of the cultivation-beds 53.

In FIG. 11, a plurality (four in the drawing) of cultivation-bed rows 61 each including a plurality of cultivation-beds 53 arranged in a line with a gradient are grouped as a cultivation-bed group 62. One cultivation-bed group 62 is provided with one sub tank 73.

Seedlings to be cultivated in the cultivation-beds 53 are the seedlings that have been raised in the first step and have been transplanted sequentially to the cultivation-beds 53 in units of one cultivation-bed group 62. That is, the seedlings are grouped in correspondence with the cultivation-bed groups 62 and include those in Day 1 of cultivation, those in Day 2 of cultivation, and further on. Since one specific nutrient solution prepared in the master tank 70 is supplied to the cultivation-beds 53 via the sub tanks 73, seedlings transplanted on the same day are cultivated under the same growing conditions.

Vegetables in any cultivation-bed groups 62 whose number of days of cultivation has reached a specified value are all harvested. In this method, workers responsible for harvesting of vegetables do not need to have a skill for distinguishing which vegetables have grown to an extent that is the best for shipment.

As illustrated in FIG. 11, since one sub tank 73 is provided for each of the cultivation-bed groups 62, the nutrient solution for cultivation can be controlled in units of a relatively small amount by the use of the sub tank 73. It is preferable that, when harvesting is completed in one cultivation-bed group 62, the nutrient solution that has been used in the cultivation-bed group 62 is disposed of, and the next cultivation is started in the cultivation-bed group 62 after a fresh nutrient solution is fed thereto.

Thus, vegetables to be cultivated in the next cycle can be cultivated stably under no influences of any secretions (such as organic acid) discharged from the roots into the nutrient solution during the cultivation in the previous cycle, or epidermal cells that have peeled off the roots or the like.

In conventional methods, seedlings are cultivated by supplying a nutrient solution to all cultivation-beds from a shared tank. Therefore, a fresh nutrient solution is added to the nutrient solution in use. Consequently, secretions discharged from the roots and epidermal cells peeled off the roots accumulate, and the repetition of such cultivation causes growth inhibition called autointoxication.

Even in the conventional methods, the entirety of the nutrient solution can be replaced. However, the entirety of the nutrient solution in the tank and in all the cultivation-beds have to be replaced at a time. In such work, a huge amount of nutrient solution needs to be disposed of at a time. Moreover, no vegetables can be cultivated during the work.

Consequently, a problem arises in that vegetables can not be shipped regularly because no vegetables can be shipped during the above work.

In FIG. 11, the nutrient solution used in one cultivation-bed group 62 flows through a piping 76 and returns to the sub tank 73 from which the nutrient solution has been supplied to the cultivation-beds 53 of the cultivation-bed group 62, whereby the nutrient solution is made to circulate. The sub tank 73 is provided with a float valve or the like and is supplied with an additional portions of the nutrient solution from the master tank 70, whereby the amount of nutrient solution in the sub tank 73 is maintained at a constant level.

In the cultivation field illustrated in FIG. 11, while cultivation is in progress in some cultivation-bed groups 62, cleaning (cleaning performed after harvesting) can be performed in other cultivation-bed groups 62. That is, different cultivation processes can proceed in different cultivation-bed groups 62.

Even if any disease germs are produced in one or more of the cultivation-bed groups 62, the contagion of the disease germs to other cultivation-bed groups 62 can be suppressed. That is, since the nutrient solution is not returned to the master tank 70, the contagion is confined within a closed circuit (the cultivation-bed group 62) through which the nutrient solution is allowed to circulate.

Each of the sub tanks 73 is preferably provided with a water feeding device 77 that feeds water thereto. In late stages of cultivation of leaf vegetables and fruit vegetables that are cultivated in the cultivation-bed groups 62, the supply of the nutrient solution is changed to the supply of water, whereby the concentration of the fertilizer in the nutrient solution circulating between the sub tank 73 and the cultivation-beds 53 can be lowered. Consequently, in late stages of cultivation, the amount of nitrate in plants can be reduced gradually. Thus, leaf vegetables and fruit vegetables containing less nitrate can be harvested.

Nitrate in plants, if taken into human bodies, bonds with amide nitrogen and generates nitrosamine. If the concentration of the fertilizer in the nutrient solution is lowered in late stages of cultivation, the concentration of nitrate in plants can be lowered. Moreover, if the concentrations of nitrogen, phosphate, and potassium in the used nutrient solution are lowered in late stages of cultivation, the load that is put on the environment at the disposal of the nutrient solution after harvesting can also be reduced dramatically.

### EXAMPLES

### Example 1

### An Exemplary Method of Cultivating Spinach

The cultivation method according to the present invention enables the daily shipment of a specific amount of vegetables. The method will now be described by taking the cultivation of spinach as an example.

In the first step, letting the unit of a block in which seeds are sown at a time be “a,” a block for the sowing on Day 1 is denoted by “a1” and a block for the sowing on Day 2 is denoted by “a2.” Sowing is performed every day in units of a predetermined block. Thus, Blocks a1, a2, a3, . . . are obtained.

In this example, a seedling-raising period (the first step) lasts for twelve days from the sowing. Seedlings of spinach on Day 12 are of substantially the same size. Seedlings of substantially the same size mean seedlings that are regarded as having grown to substantially the same extent. For example, the seedlings each have two to three leaves. In terms of the state of growth of the roots in seedling-root pots, the seedlings each have roots spreading to such an extent that the seedling can be easily taken out of the hole provided in the cell tray, and the culture medium forming the seedling-root pot retains its shape, without crumbling, even if the seedling is taken out.

The seedlings in Block al where seeds were sown on Day 1 in the first step are transplanted to the planting panels of a cultivation-bed group 62 for the second step on Day 12. Block al from which the seedling have been transplanted is used for sowing again after being cleaned, according to need.

The cultivation of spinach in the second step lasts for 14 days. Such spinach is ready to be shipped. As described above, since the seedlings in Blocks a1, a2, a3, . . . raised in the first step are sequentially settled in the second step, transplanting can be performed on a daily basis. At the beginning of the cultivation, a nutrient solution at a specified concentration is supplied from the master tank 70 to relevant sub tanks 73.

In the second step, the seedlings in each of the blocks sequentially transplanted from the first step grow at substantially the same rate. After a predetermined number of days, they are harvested and shipped.

The cultivation-beds included in the cultivation-bed groups used in the second step are cleaned after harvesting. Any secretions (organic acid or the like) discharged from the roots into the nutrient solution and epidermal cells peeled off the roots are removed from the nutrient solution, and the nutrient solution is replaced with a fresh nutrient solution.

Cultivation of seedlings in the other cultivation-bed groups is in progress even during the above work. Thus, cultivation of vegetables is continued, and such vegetables can be harvested regularly.

While a specific embodiment of the present invention has been described in detail above, it is obvious to those skilled in the art that various modifications can be made to the embodiment without departing from the essence and scope of the present invention.

This application claims the benefit of Japanese Patent Application No. 2014-105370 filed May 21, 2014, which is hereby incorporated by reference herein in its entirety.

### REFERENCE SIGNS LIST

1 closed building structure

3, 4, 5, 6 multi-shelf raising module

7 to 10 air-conditioning device

12 seedling-raising shelf

13 artificial illuminator

15 air fan

16 carbon-dioxide cylinder

30 irrigation device

31 irrigation tray

33 water supply pipe

34 dam

35 rib

40 cell tray

41 cell

42 cell hole

53 cultivation-bed

61 cultivation-bed row

62 cultivation-bed group

70 master tank

73 sub tank

1. A plant cultivation method comprising first raising seedlings, and second planting the seedlings into a cultivation field and cultivating the seedlings,
wherein, in said raising, the seedlings are cultivated with only artificial light;
in said planting, the seedlings are cultivated with only sunlight; and
said raised seedlings are sequentially transplanted to the cultivation field and are cultivated.

2. The plant cultivation method according to claim 1,
wherein the cultivation field is provided with at least one cultivation-bed, a master tank in which a nutrient solution is stored, and at least one sub tank to which the nutrient solution is supplied from the master tank; and
the nutrient solution is supplied from the sub tank to the cultivation-bed.

3. The plant cultivation method according to claim 2, wherein the nutrient solution used in the cultivation-bed is returned to the sub tank from which the nutrient solution has been supplied to said cultivation-bed.

4. The plant cultivation method according to claim 2,
wherein the cultivation-bed is arranged with a gradient;
the cultivation-bed carries a planting panel having a number of planting holes for planting seedlings;
seedlings are put into the planting holes; and
the seedlings are cultivated by causing the nutrient solution to flow along a bottom surface of the cultivation-bed.

5. The plant cultivation method according to claim 2, wherein, in a late stage of cultivation of plants in the cultivation-bed, the supply of the nutrient solution to the cultivation-bed is stopped, and water is supplied to the cultivation-bed.

6. The plant cultivation method according to claim 1, wherein said raising is performed in a seedling-raising apparatus;
the seedling-raising apparatus includes a completely light-shielded closed structure;
a plurality of raising modules each including a plurality of seedling-raising shelves arc provided in an internal space of the closed structure;
an air-conditioning device is provided in the internal space of the closed structure;
cell trays in each of which a culture medium is provided are placed on the respective seedling-raising shelves of the raising modules;
light is applied to each of the cell trays from above by an artificial illumination device; and
seedlings are raised while each of the cell trays is irrigated from a bottom face of the cell tray by an automatic irrigation device.

7. A plant cultivation facility for cultivating plants, the facility comprising:
a young-seedling-raising area in which young seedlings of the plants are cultivated with only artificial light; and
a transplanted seedlings cultivation area in which the seedlings grown in the young-seedlings-raising area are cultivated with only sunlight.

8. The plant cultivation facility according to claim 7, wherein the transplanted seedlings cultivation area is provided with a master tank in which a nutrient solution is stored, at least one sub tank to which the nutrient solution is supplied from the master tank, and at least one cultivation-bed to which the nutrient solution is supplied from the sub tank

9. The plant cultivation facility according to claim 8, wherein the transplanted seedlings cultivation area is further provided with a return circuit in which the nutrient solution used in the cultivation-bed is returned to the sub tank

10. The plant cultivation facility according to claim 8,
wherein the cultivation-bed is arranged with a gradient;
the cultivation-bed carries a planting panel having a number of planting holes for planting seedlings;
seedlings are put into the planting holes; and
the seedlings are cultivated by causing the nutrient solution to flow along a bottom surface of the cultivation-bed.

11. The plant cultivation facility according to claim 8, wherein, in a late stage of cultivation of plants in the cultivation-bed, the supply of the nutrient solution to the cultivation-bed is stopped, and water is supplied to the cultivation-bed.

12. The plant cultivation facility according to claim 7,
wherein the seedlings are raised in the young-seedling-raising area with only artificial light;
the young-seedling-raising area is provided with a completely light-shielded closed structure;
a plurality of raising modules each including a plurality of seedling-raising shelves are provided in an internal space of the closed structure;
an air-conditioning device is provided in the internal space of the closed structure;
cell trays in each of which a culture medium is provided are placed on the respective seedling-raising shelves of the raising modules;
light is applied to each of the cell trays from above by an artificial illumination device; and
seedlings are raised while each of the cell trays is irrigated from a bottom face of the cell tray by an automatic irrigation device.
